(19) United States
(12) Patent Application Publication
(10) Pub. No.: US 2020/0073517 A1
(43) Pub. Date: Mar. 5, 2020

(54) BEHAVIOR BASED SWITCHING MECHANISM FOR ELECTRONIC CONTENT ITEMS

(71) Applicant: MICROSOFT TECHNOLOGY LICENSING, LLC, Redmond, WA (US)

(72) Inventors: Tao Cai, Sunnyvale, CA (US); Pallavi Agarwal, Mountain View, CA (US)

(21) Appl. No.: 16/119,401

(22) Filed: Aug. 31, 2018

(51) Int. Cl. G06F 3/0482; G06F 9/451; G06F 3/0485

(52) U.S. Cl. CPC G06F 3/0482; G06F 3/0485; G06F 9/451

(57) ABSTRACT

Techniques for switching content items to improve presentation of one or more content items are provided. In one technique, a plurality of content items associated with a particular slot in a user interface is received by an application. A first content item of the plurality of content items is caused to be displayed in the particular slot in the user interface presented to a client computing device. After the first content item is caused to be displayed in the particular slot, a user input to scroll through the plurality of content items is received. After scrolling through the plurality of content items, a particular slot is detected to be no longer in view and a second content item from the plurality of content items different from the first content item is selected. The second content item is caused to be displayed in the particular slot by the application.

### TECHNICAL FIELD

The present disclosure relates to content item delivery across one or more computer networks and, more particularly to, a behavior-based switching mechanism for electronic content items.

### BACKGROUND

The Internet allows end users operating computing devices to request content from many different publisher systems. Some publishers desire to send content items to users who visit their respective websites or who otherwise interact with the publishers. To do so, publisher systems rely on external content delivery services that deliver the content items over one or more computer networks to computing devices of such users.

Some content providers of the content items rely on one or more content delivery services to electronically distribute their respective content items. Content delivery services and publisher systems implement a single content approach where a single piece of content from a content provider is presented within a single slot made available by a publisher system. However, such an approach limits the amount of content that the content provider can present to end users and that end users can view.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIGS. 2A-2D are example user interfaces for switching one or more content items in a single slot, in an embodiment;

FIG. 3 is a flow diagram that depicts a process for switching content items in the single slot, in an embodiment; and

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A method and system for switching and displaying multiple content items in a single slot are provided. One or more content items are available to be displayed in a single slot and at least one content item is presented in the single slot in the web content or mobile application content. Upon detecting that the single slot is no longer in view, a content item displayed in the single slot is switched out with another content item that is different than the originally-displayed content item. Switchable content items allow content providers to provide a variety of content items to an end user in the single slot. Prior to this approach, a content provider was limited to a single content item per slot. However, with more content items to display, it is unknown which content item will have a greater impact on the engagement and conversion of the content item. Approaches described herein allow content items to be interacted with and tracked to determine which methods and approaches have the greatest impact on content item conversion and performance.

### Technical Improvements

Embodiments described herein improve the utility of electronic content delivery systems for content providers and end users by providing a variety of content items in a single slot in web content. Embodiments also improve performance and conversion of content items by tracking user engagement with content items and respective content item configurations. Embodiments described herein overcome a problem specifically arising in a limited graphical user interface display by dynamically switching visual and textual information in a single slot within an underlying window displayed in a graphical user interface. Embodiments also optimize the usability of the graphical user interface to provide an enhanced user interaction and experience with a computing device.

### System Overview

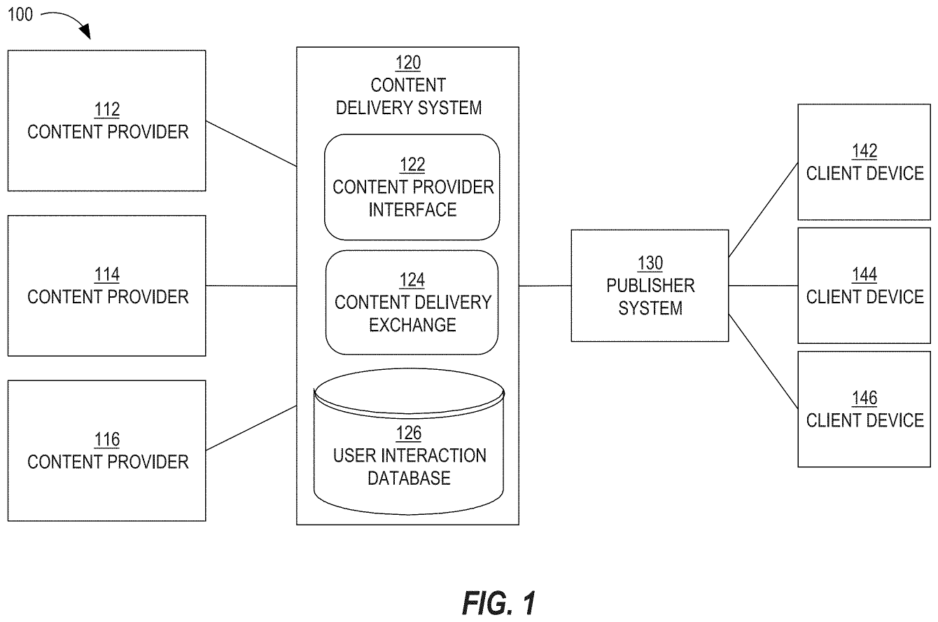

FIG. 1 is a block diagram that depicts a system 100 for distributing content items to one or more end-users, in an embodiment. System 100 includes content providers 112-116, a content delivery system 120, a publisher system 130, and client devices 142-146. Although three content providers are depicted, system 100 may include more or less content providers. Similarly, system 100 may include more than one publisher and more or less client devices.

Content providers 112-116 interact with content delivery system 120 (e.g., over a network, such as a LAN, WAN, or the Internet) to enable content items to be presented, through publisher system 130, to end-users operating client devices 142-146. Thus, content providers 112-116 provide content items to content delivery system 120, which in turn selects content items to provide to publisher system 130 for presentation to users of client devices 142-146. However, at the time that content provider 112 registers with content delivery system 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery system 120.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a content provider interface 122 that allows content providers 112-116 to create and manage their respective content delivery campaigns and (2) a content delivery exchange 124 that conducts content item selection events in response to content requests from a third-party content delivery exchange and/or from publisher systems, such as publisher system 130.

Publisher system 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application (e.g., a native mobile application) that is configured to only communicate with publisher system 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher system 130.

In response to receiving a content request, content delivery exchange 124 initiates a content item selection event that involves selecting one or more content items (from among multiple content items) to present to the client device that initiated the content request. An example of a content item selection event is an auction.

Content delivery system 120 and publisher system 130 may be owned and operated by the same entity or party. Alternatively, content delivery system 120 and publisher system 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 124, and that bids for space (on one or more publisher systems, such as publisher system 130) to present content items on behalf of multiple content providers. Thus, a bidder is another source of content items that content delivery exchange 124 may select for presentation through publisher system 130. Thus, a bidder acts as a content provider to content delivery exchange 124 or publisher system 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery system 120 through, for example, content provider interface 122. An example of content provider interface 122 is Campaign Manager™ provided by LinkedIn. Content provider interface 122 comprises a set of user interfaces that allow a representative of a content provider to create an account for the content provider, create one or more content delivery campaigns within the account, and establish one or more attributes of each content delivery campaign. Examples of campaign attributes are described in detail below.

A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign is an organized way to present information to users that qualify for the campaign. Different content providers have different purposes in establishing a content delivery campaign. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select, or click on the set of content items, when a certain number of users purchase a product/service associated with the content delivery campaign or fill out a particular form on a website, or when a budget of the content delivery campaign has been exhausted.

A content delivery campaign may specify one or more targeting criteria that are used to determine whether to present a content item of the content delivery campaign to one or more users. (In most content delivery systems, targeting criteria cannot be so granular as to target individual members.) Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery campaign are not sent to the computing device.

Thus, content delivery exchange 124 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery exchange 124 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher system 130 may not satisfy targeting criteria of one content item of a campaign, the same content request may satisfy targeting criteria of another content item of the campaign.

Different content delivery campaigns that content delivery system 120 manages may have different charge models. For example, content delivery system 120 (or, rather, the entity that operates content delivery system 120) may charge a content provider of one content delivery campaign for each presentation of a content item from the content delivery campaign (referred to herein as cost per impression or CPM). Content delivery system 120 may charge a content provider of another content delivery campaign for each time a user interacts with a content item from the content delivery campaign, such as selecting or clicking on the content item (referred to herein as cost per click or CPC). Content delivery system 120 may charge a content provider of another content delivery campaign for each time a user performs a particular action, such as purchasing a product or service, downloading a software application, or filling out a form (referred to herein as cost per action or CPA). Content delivery system 120 may manage only campaigns that are of the same type of charging model or may manage campaigns that are of any combination of the three types of charging models.

A content delivery campaign may be associated with a resource budget that indicates how much the corresponding content provider is willing to be charged by content delivery system 120, such as $100 or $5,200. A content delivery campaign may also be associated with a bid amount that indicates how much the corresponding content provider is willing to be charged for each impression, click, or other action. For example, a CPM campaign may bid five cents for an impression, a CPC campaign may bid five dollars for a click, and a CPA campaign may bid five hundred dollars for a conversion (e.g., a purchase of a product or service).

### Content Item Selection Events

As mentioned previously, a content item selection event is when multiple content items (e.g., from different content delivery campaigns) are considered and a subset selected for presentation on a computing device in response to a request. Thus, each content request that content delivery exchange 124 receives triggers a content item selection event.

For example, in response to receiving a content request, content delivery exchange 124 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 124 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery system 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 124 conducts one or more content item selection events. Thus, content delivery exchange 124 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that operates content delivery system 120 conducts one or more content item selection events. In this latter embodiment, content delivery system 120 sends one or more content items to the other exchange, which selects one or more content items from among multiple content items that the other exchange receives from multiple sources. In this embodiment, content delivery exchange 124 does not necessarily know (a) which content item was selected if the selected content item was from a different source than content delivery system 120 or (b) the bid prices of each content item that was part of the content item selection event. Thus, the other exchange may provide, to content delivery system 120, information regarding one or more bid prices and, optionally, other information associated with the content item(s) that was/were selected during a content item selection event, information such as the minimum winning bid or the highest bid of the content item that was not selected during the content item selection event.

### Overview of Tracking User Interactions

Content delivery system 120 tracks one or more types of user interactions across client devices 142-146 (and other client devices not depicted). For example, content delivery system 120 determines whether a content item that content delivery exchange 124 delivers is presented at (e.g., displayed by or played back at) a client device. Such a “user interaction” is referred to as an “impression.” As another example, content delivery system 120 determines whether a content item that exchange 124 delivers is selected by a user of a client device. Such a “user interaction” is referred to as a “click.” Content delivery system 120 stores such data as user interaction data, such as an impression data set and/or a click data set. Thus, content delivery system 120 may include a user interaction database 126.

For example, content delivery system 120 receives impression data items, each of which is associated with a different instance of an impression and a particular content delivery campaign. An impression data item may indicate a particular content delivery campaign, a specific content item, a date of the impression, a time of the impression, a particular publisher or source (e.g., onsite v. offsite), a particular client device that displayed the specific content item, and/or a browser cookie. Thus, if content delivery system 120 manages multiple content delivery campaigns, then different impression data items may be associated with different content delivery campaigns. One or more of these individual data items may be encrypted to protect privacy of the end-user.

Similarly, a click data item may indicate a particular content delivery campaign, a specific content item, a date of the user selection, a time of the user selection, a particular publisher or source (e.g., onsite v. offsite), a particular client device that displayed the specific content item, and/or a browser cookie. If impression data items are generated and processed properly, a click data item should be associated with an impression data item that corresponds to the click data item.

### Event Logging

Content delivery system 120 may log one or more types of events, with respect to content item summaries, across client devices 152-156 (and other client devices not depicted). For example, content delivery system 120 determines whether a content item summary that content delivery exchange 124 delivers is presented at (e.g., displayed by or played back at) a client device. Such an “event” is referred to as an “impression.” As another example, content delivery system 120 determines whether a content item summary that exchange 124 delivers is selected by a user of a client device. Such a “user interaction” is referred to as a “click.” Content delivery system 120 stores such data as user interaction data, such as an impression data set and/or a click data set. Thus, content delivery system 120 may include a user interaction database 126. Logging such events allows content delivery system 120 to track how well different content items and/or campaigns perform.

For example, content delivery system 120 receives impression data items, each of which is associated with a different instance of an impression and a particular content item summary. An impression data item may indicate a particular content item, a date of the impression, a time of the impression, a particular publisher or source (e.g., onsite v. offsite), a particular client device that displayed the specific content item (e.g., through a client device identifier), and/or a user identifier of a user that operates the particular client device. Thus, if content delivery system 120 manages delivery of multiple content items, then different impression data items may be associated with different content items. One or more of these individual data items may be encrypted to protect privacy of the end-user.

Similarly, a click data item may indicate a particular content item summary, a date of the user selection, a time of the user selection, a particular publisher or source (e.g., onsite v. offsite), a particular client device that displayed the specific content item, and/or a user identifier of a user that operates the particular client device. If impression data items are generated and processed properly, a click data item should be associated with an impression data item that corresponds to the click data item. From click data items and impression data items associated with a content item summary, content delivery system 120 may calculate a CTR for the content item summary.

### Switching Content Items

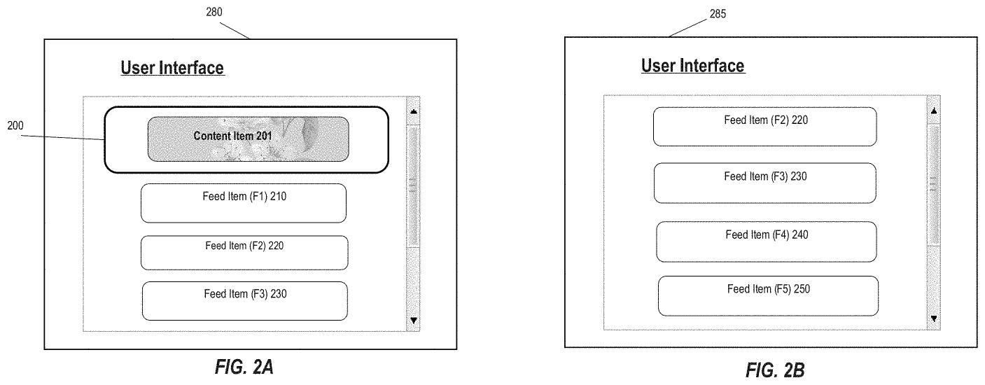

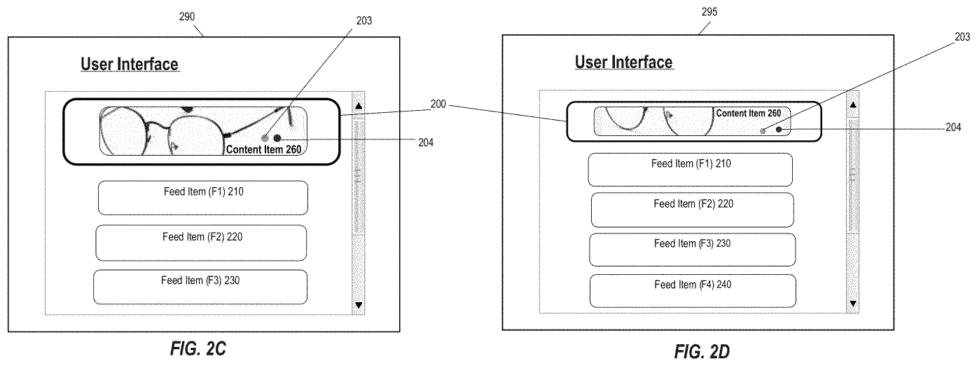

FIGS. 2A-2D are example user interfaces for displaying and switching multiple content items in a single slot, in an embodiment.

FIG. 2A is a first example user interface 280, provided by publisher system 130 that displays a content item 201 and one or more feed items 210, 220, and 230, in an embodiment. User interface 280 includes:
a content item 201 that involves an article, image, and/or text that originates from the content provider;
a slot 200 that includes content item 201; and
feed items 210, 220, and 230—each of the feed items involves an article, image, news items, video, and/or postings by a user.

FIG. 2B is a second example user interface 285 that displays different feed items than the example user interface 280, in an embodiment. The content item 201 may disappear from the user interface 285 as the user provides scrolling down input to see other feed items. As a result, the slot 200 and the first feed item 210 on the user interface 280 are no longer presented in the user interface 285. Instead, new feed items 240 and 250 which were not part of the user interface 280 may appear on the user interface 285.

FIG. 2C is a third example user interface 290 that displays a different content item 260 and one or more feed items, in an embodiment. As illustrated in FIG. 2B, the slot 200 is no longer viewable from the user interface 285. Upon detecting that the slot 200 is no longer viewable, a client application (e.g., a mobile application or a web browser) is configured to select a content item 260, from a plurality of content items, that is different than content item 201. As shown in FIG. 2C, content item 260 is caused to be displayed in the slot 200.

In some embodiments, the client application may determine that content item 201 was displayed in the slot 200 a threshold number of times. The threshold number may vary based on example user attributes that may be applied to the calculation of the threshold number. The example user attributes include types of users, characteristics of users to which the content items are presented, user behavioral history, attributes of the computing device, the identity of the publisher, etc. The example user attributes listed herein are not an exclusive list and can include other attribute factors. Generally, users are no longer interested in the currently presented content item if the currently presented content item has been displayed more than two times. In this case, the threshold number can be two. In another case, the threshold number can be greater than two.

In some embodiments, a visual indicator is displayed in the slot together with a content item. For example, a single slot can contain one or more visual indicators and each visual indicator may be associated with a respective content item. A first visual indicator 203 is associated with content item 201 and a second visual indicator 204 is associated with content item 260. While the content item 201 is displayed in the slot 200, the first visual indicator 203 may be highlighted to indicate the corresponding content item 201 is currently displayed in the slot 200. On the other hand, while the content item 260 is displayed in the slot 200, the second visual indicator 204 may be highlighted to indicate that the content item 260 is displayed in the slot 200. As illustrated in FIG. 2C, the second visual indicator 204 is highlighted to indicate that the corresponding content item (e.g., content item 260) is currently displayed in the slot 200.

While the content item 260 is displayed in the slot 200, the user can select the first visual indicator 203 to replace the currently displayed content item (e.g., content item 260) with the content item 201. Upon receiving the selection, the currently presented content item (e.g., content item 260) is replaced with the previously presented content item (e.g., content item 201) and the content item 201 is caused to be displayed in the slot 200.

FIG. 2D is a fourth example user interface 295 that displays a portion of the slot 200 and one or more feed items 210, 220, and 230. As illustrated in a smaller sized slot 200, only a portion of the slot 200 may be viewable on the user interface 295 as the user provides input to scroll through the feed items. While the content item 201 is displayed in the slot 200, if the system detects user input (e.g., scrolling down) which causes the change in the slot size, then the client application causes the second content item (e.g., content item 260) to be selected and displayed in the slot 200.

In some embodiments, a plurality of content items can be received by the content providers 112, 114, and 116. The plurality of content items may be qualified to be displayed in slot 200 and ranked based on the respective selection factors. However, a content item might not be qualified to be displayed as the second content item if the content item may have lower CTR than other content items. In another embodiment, a content item might not be qualified to be displayed as the second content item if the content item may have lower quality content (e.g., the content item including grammar errors). In another embodiment, a content item might not be qualified to be displayed as the second content item if the content item may come from a less reputable content provider (e.g., content provider 112 v. content provider 114).

In some embodiments, different types of computing devices can change the placement of content items within the user interface. For example, the screen size of the computing device can affect the location of the content items in the user interface in connection with the respective user behavior. Typically, users scroll faster on the mobile devices than when using desktop devices since the screen size is smaller on the mobile device. The faster scrolling speed can impact the user behavior with respect to the engagement with the content items. Engagement with the content items on the mobile devices is facilitated as it would require less effort for the users to move a cursor on the mobile device than the desktop device. As a result, certain types of computing devices allow a higher engagement with the content items and a different placement of the content item is encouraged accordingly (e.g., on the right side of the user interface).

In another embodiment, different types of web applications can change the placement of the content items within the user interface. For example, based on the location of feed items, certain web applications can affect the location of the content items in the user interface and the respective user behavior. Typically, users scroll downwards to see new feed items that the users have not yet seen. Consequently, the users are not likely to scroll upwards to view the previously-viewed feed items. If the slot containing a content item is located on the top of the user interface, the user is less likely to view the slot again because the user is not likely to scroll back up to view the slot. Thus, the location of feed items in different web applications can impact the user behavior concerning the engagement with the feed items and content item. As a result, a different location of the content item may be encouraged to provide a higher engagement with the content item in certain user interface (e.g., by placing the content item on the bottom of the user interface).

In some embodiments, a content provider of the content item 260 may be different from a content provider of the content item 201. In another embodiment, the content provider of the content item 260 can be the same content provider as the content provider of the content item 201.

### Example Selection Factors

### A. Impression Counts

When a content item is presented on a client device, the client device transmits, to a tracking service (e.g., internal to, or external to, content delivery exchange 124), an impression message that reports on an impression event (or simply “impression”). An impression message identifies the presented content item and one or more attributes of the content item and/or of the corresponding content delivery campaign. The impression message may be an HTTP message and the one or more attributes may be encoded in a uniform resource locator (URL), such as a content item identifier and/or a content delivery campaign identifier. An impression message can be generated by a client application that presents the content item, such as a smartphone application or a web browser application. In some embodiments, the impression message can be generated by content delivery exchange 124 or publisher system 130. The impression message may include impression counts and impression time for each content item.

In some embodiments, the content item is switched out or replaced based on an impression count of the content item. As used herein, the term “impression count” is intended to refer to a number of times that a particular content item is presented on the client device in a single session with publisher system 130, where each pair of presentation times is separated by a time when the particular content item is not displayed or in view (e.g., as a result of scrolling to a portion of web content where the particular content item is not visible). If the particular content item is presented on the client device and the user has stayed on the web page that includes the particular content item for more than a threshold amount of time, then the client application is configured to count each time the particular content item was displayed and calculate the impression count. An impression count can be generated on a per-content item basis.

For example, if the user has seen the same content item more than twice and if the user has not yet clicked on the content item, then the client application determines that the user lost interest in that content item and determines that the user is less likely to click on that content item. Consequently, the client application determines that a different content item may attract the user and replaces the content item with a new content item and presents the new content item on the client device. Effective impression count can vary based on the types of users, the types of content items, or the density of the content items.

For example, an effective impression count for a text-based content item may be three and an effective impression for a dynamic content item (e.g., video) may be two as the dynamic content item is more likely to attract users than the text-based content item. In another example, an effective impression count for an active user (e.g., spend a considerable amount of time on the connections network) may be two and a passive user (e.g., spend little time on the connections network) may be four as the active user is more likely to engage with the content item than the passive user. In some cases, an effective impression count for a high-density content item (e.g., a content item with lots of information) may be two and an effective impression rate for a low-density content item (e.g., a content item with less information) may be four as the high-density content item is more informative than the low-density content item.

### B. Impression Time

In some embodiments, a content item is switched out or replaced with another content item based on an impression time of the content item. As used herein, the term “impression time” is intended to refer to an amount of time a particular content item is presented to the client device. In other words, the impression time is a view time, an amount of time the user spends on the web content to view a particular content item. The client application calculates the impression time and determines whether the impression time is longer than a threshold amount of time. For example, if the impression time is less than one second, then the system may determine that the user did not have enough time to assess the content item. However, if the impression time is longer than one minute, then the system may determine that the user had enough time to view and assess the content item. In another embodiment, publisher system 130 or content delivery system 120 may determine whether the impression time is longer than the threshold amount of time based on one or more impression times received from the client application.

In an embodiment, when a content item is presented on the client device, the client device transmits (e.g., to content delivery exchange 124) the impression message that includes the impression time. The impression time is indicative of a user's interest in the particular content item that is presented to the user. The client application determines that the longer the impression time is, the more the user is interested in the content item. For example, if the first content item is related to a particular type of object (e.g., computer) and spend more than a threshold amount of time (e.g., five minutes), then the system determines that the user has interests in the object and will likely to present a second content item that is similar to the first content item in its character (e.g., computer-related service or object). On the other hand, if the user spends less than a minute in viewing the first content item (e.g., computer), then the system determines that the user has no interest in the computer-related object and may switch to a non-computer related object or service (e.g., book) for the second content item.

### C. Gap Time Between Impression Events of Content Items

In some embodiments, a content item is switched out or replaced based on the gap time between impressions of the content items. As used herein, the “gap time” is intended to refer to a difference in time between when a slot disappears and when the slot is back in view. In other words, the client application records a time when the user stops viewing the web content that includes the slot and a time when the user again starts viewing the web content that includes the slot and calculates the gap time based on the respective recorded times. Based on the gap time, the client application can select a second content item from a plurality of content items that is different from the first content item. In some embodiments, the client application determines whether the gap time is greater than a threshold amount and selects the second content item.

In an embodiment, when a content item is presented on a client device, the client device transmits to content delivery exchange 124 the impression message that includes the gap time between when the slot disappears and when the slot is back in view in web content. The gap time is indicative of a user's interest in the particular content item that is presented to the user. In some embodiments, the client application may determine that the shorter the gap time, the more the user is interested in the content item. For example, the user is more likely to click on the content item if the user is exposed to the same or similar content items for a longer period of time. For example, if the slot displays a new content item that is similar to an originally-displayed content item in its attributes (e.g., pet-related service) within a threshold amount of time after displaying the originally-displayed content item and the user stays in the web page that includes the slot, the client application may determine that the user is interested in either the originally-displayed content item or the currently-displayed content item. The user's exposure to the content items can be increased by reducing the gap time between impressions of the similar content items.

### D. Click-Through Rate (CTR)

In some embodiments, a content item is switched out or replaced based on a user selection rate (e.g., a click-through rate (CTR)) of the content item. In one embodiment, a CTR can be calculated on a per-user basis. For example, a CTR of user A refers to a ratio of a number of clicks on any content items by user A to a number of impressions of all content items to user A. In general, the CTR of a user increases if the user frequently clicks on the content items that are presented to the user.

The CTR can be determined based on a frequency cap rule (fcap). For example, the client application receives up-to-date fcap information from the server side (e.g., the user has seen a particular content item twice in a twenty-four hour period). The client application further counts a number of times the user has seen the particular content item in the same session and adds that count information to the received fcap information to generate a fcap rule. The client application can apply the fcap rule to select a content item different from the first content item from a plurality of content items.

In some embodiments, the CTR of a user can be calculated based on example criteria which may include an order in which a plurality of content items is presented to the user, impression times of the content items, impression count, and/or gap time between the slot disappears from view and when the slot is back in view. For example, a first content item that is medium interest to the user may be presented on the client device. The user might not be interested in clicking the first content item yet. After the first content item is no longer in view, the slot may display a second content item that is partially related to the first content item. The user who was not sure about the first content item may now be interested in clicking the second content item if the second content item is presented to the user right after the first content item, resulting in the CTR of the user to increase.

Typically, the CTR of a user is generated at the server side and communicated to the client device. At the client device, as the user interacts with content items, data regarding the CTR for that user is collected and communicated to the server side to update the CTR based on the user activity. The updated CTR is stored in the user interaction database 126 and sent to the client device to be applied at the client device.

In some embodiments, the client device (e.g., web application, a native mobile application, etc.) is unable to communicate with the server side to transmit the data regarding CTR. Consequently, the client device autonomously updates the CTR based on the user's interaction with the content item. The updated CTR can be used to select the second content item and to determine when to display the second content item in the slot.

In some embodiments, a content item may be switched out or replaced based on a CTR of a content item. The CTR of a content item refers to a ratio of a number of clicks on a particular content item by one or more users who have viewed the particular content item. In general, the CTR of a content item increases if more users click on the particular content item.

In some embodiments, the CTR of a content item and a CTR of a user can be combined to create a combined CTR. The combined CTR can be calculated during serving time of the content item. Subsequently, the client application counts and collects view counts, view time, or view gap of the content items presented to the user(s). The combined CTR can be re-adjusted to incorporate the collected data during the serving of the content item. The updated combined CTR can be referred to herein as a “switchable CTR.” The switchable CTR can be different from the original combined CTR that was calculated before the data is collected. The client application can determine to switch a content item presented to the user based on the switchable CTR.

For example, user A may be presented with a content item A two times. Since the content item A is displayed in the slot, it is determined that the CTR of a content item A may be higher than CTRs of other content items. If the user A does not click on the content item A after the content item A is shown twice, then the CTR of content item A may be re-adjusted based on the user interaction with the content item A. After re-adjusting the CTR of content item A, the client application may determine that CTR of content item B is now higher than the CTR of content item A. Consequently, the content item B may be presented to the user in the slot.

### E. Viewing Metrics

In some embodiments, a content item is switched out or replaced based on viewing metrics. The system measures the position of the slot with respective of the feed items in the web content. For example, the system may detect that the position of the slot moves along with one or more feed items in the user interface as the user provides input to scroll through the feed items. The system can measure the position metrics for the slot that contains the content item on the screen of the client device and recalculate the position metrics of the slot after the user provides the input. The system can compare these position metrics and determine the difference in viewing metrics.

For example, the slot may no longer be in view or only a portion of the slot may in view as the user provides the input on the client device, resulting in the change in the position metrics. The second content item can be selected based at least in part on the change in the viewing metrics of the slot. In other words, detecting a change in the pixel line of the slot on the screen can cause the second content item different from the first content item to be selected and displayed in the slot.

### F. User-Specific Rules

In an embodiment, a second content item is selected based on the user behavior history information. The client application identifies a computing device that is associated with a particular user and identifies a user-specific rule which is built upon previous activity for the particular user that includes the user interaction data and effective content item delivery rules. The user interaction data can be received from the user interaction database 126. The user interaction data can include information about the selection criteria described below. Based on the user-specific rule, the client application selects a second content item different from the first content item and displays the second content item in the slot in the web content.

The user behavior history information can be collected, aggregated and stored in the user interaction database 126. Example user attributes and user behaviors include:
job title, geography (e.g., North America-California), user behavior (e.g., scrolls the cursor fast or do not stay on the same page more than five minutes), frequency of logging in the connections network (e.g., heavy user), frequency of engaging with content items (e.g., every five content items), client device (e.g., Android operating system), average impression count (e.g., two), average impression time (e.g., three minutes), average CTR (e.g., 10%), average gap time between impression events of content items (e.g., ten minutes).

The user behavior data is aggregated and categorized based on the attributes. The aggregated data pertaining to a particular content item may be presented (e.g., in the form of a report) to a content provider that initiated the particular content item. The aggregated data may be presented to one or more administrators of content delivery exchange 124 to inform them of which data may be used to identify user's preferences in viewing content items or effective content delivery mechanism.

Similarly, a second content item may be selected based on the content item history information. The client application can build content item history information based on one or more users' interactions with a particular content item. For example, the client application can collect data regarding the view time, view gap, view count for the particular content item and send the information to the user interaction database 126. The content item history information can be stored in the user interaction database 126.

### When a User-Specific Rule for a Particular User is Unavailable

When the user behavior data or user-specific rule for the particular user is unavailable, the system gathers data for a plurality of users that are similar to the particular user based on one or more user attributes. For example, for one or more users who have a similar background to the particular user, the above-listed user attributes are collected and categorized.

Firstly, the system identifies a plurality of users who has seen the first content item and their respective similarity values. The similarity values include one or more values for each user attribute. Each user attribute value can be combined and averaged out to generate a similarity value. For each user of the plurality of users, the similarity value is compared with a threshold similarity value (i.e., the threshold level of similarity). If the similarity value exceeds the threshold similarity value, the system determines that the user is similar enough to the particular user who has seen the first content item and will perform in a similar way. For each user of the plurality of users whose similarity value exceeds the threshold level of similarity, user interaction data is collected from the user interaction database 126. The collected user interaction data is aggregated to generate aggregated user data for the first content item. Based on the aggregated data, the client application can determine a CTR of a user for the next consecutive content items that will be presented to the user. The client application can also select a second content item from the plurality of content items based on the aggregated data. In another embodiment, the server side (e.g., content delivery exchange 124 or publisher system 130) can select the second content item from the plurality of content items provided by the content providers 112, 114, and 116 based on the aggregated data.

### Example Content Delivery Process

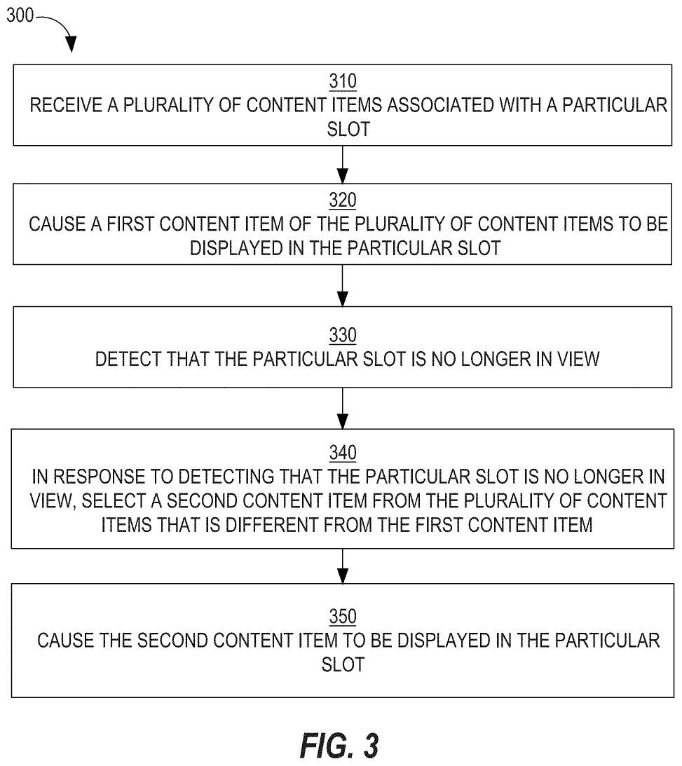

FIG. 3 is a flow diagram that depicts a process 300 for displaying and switching multiple content items in a single slot, in an embodiment. Process 300 may be implemented by content delivery exchange 124 or publisher system 130. In some embodiments, process 300 can be implemented by the client application.

At block 310, a plurality of content items associated with a particular slot in a user interface is received. The user interface comprises (1) one or more feed items that involves an article, image, news items, video, and/or postings by a user and (2) a content item that involves an article, image, and/or text that originates from a content provider. The plurality of content items may be received from the content delivery system 124 and the feed items can be received from the publisher system 130.

At block 320, a first content item is caused to be displayed in the particular slot in the user interface. The first content item can involve an article, image, and/or text that originates from the first content provider. The first content item can be displayed along with one or more feed items posted by the user.

At block 330, after the first content item is caused to be displayed in the particular slot, the computing device detects that the particular slot is no longer in view. In one embodiment, the particular slot might not be viewable because the user scrolls through the user interface to view different feed items. In another embodiment, the web page may be refreshed due to the networking errors or upon a user request, resulting in an obstructed view of the particular slot. In some embodiments, executing another program or application may generate a new window that may overlap the particular slot, which can also obscure the user's view from the particular slot.

At block 340, a second content item from the plurality of content items is selected in response to detecting that the particular slot is no longer in view. The second content item is different from the first content item which was previously displayed in the particular slot. The second content item can involve an article, image and/or text that originates from the second content provider which is different from the first content item provider. Selecting the second content item can also be performed based on example selection factors described above.

At block 350, the second content item is caused to be displayed in the particular slot along with one or more feed items, such as the same one or more feed items that were displayed concurrently with the first content item.

### Hardware Overview

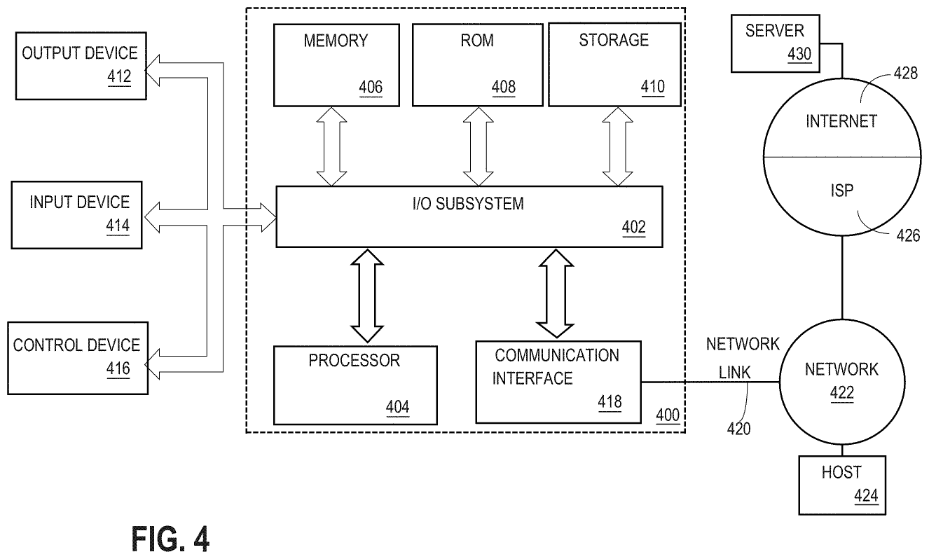

FIG. 4 is a block diagram that illustrates an example computer system with which an embodiment may be implemented. In the example of FIG. 4, a computer system 400 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 400 includes an input/output (I/O) subsystem 402 which may include a bus and/or other communication mechanism(s) for communicating information and/or instructions between the components of the computer system 400 over electronic signal paths. The I/O subsystem 402 may include an I/O controller, a memory controller and at least one I/O port. The electronic signal paths are represented schematically in the drawings, for example as lines, unidirectional arrows, or bidirectional arrows.

At least one hardware processor 404 is coupled to I/O subsystem 402 for processing information and instructions. Hardware processor 404 may include, for example, a general-purpose microprocessor or microcontroller and/or a special-purpose microprocessor such as an embedded system or a graphics processing unit (GPU) or a digital signal processor or ARM processor. Processor 404 may comprise an integrated arithmetic logic unit (ALU) or may be coupled to a separate ALU.

Computer system 400 includes one or more units of memory 406, such as a main memory, which is coupled to I/O subsystem 402 for electronically digitally storing data and instructions to be executed by processor 404. Memory 406 may include volatile memory such as various forms of random-access memory (RAM) or other dynamic storage device. Memory 406 also may be used for storing temporary variables or other intermediate information during execution of instructions to be executed by processor 404. Such instructions, when stored in non-transitory computer-readable storage media accessible to processor 404, can render computer system 400 into a special-purpose machine that is customized to perform the operations specified in the instructions.

Computer system 400 further includes non-volatile memory such as read only memory (ROM) 408 or other static storage device coupled to I/O subsystem 402 for storing information and instructions for processor 404. The ROM 408 may include various forms of programmable ROM (PROM) such as erasable PROM (EPROM) or electrically erasable PROM (EEPROM). A unit of persistent storage 410 may include various forms of non-volatile RAM (NVRAM), such as FLASH memory, or solid-state storage, magnetic disk or optical disk such as CD-ROM or DVD-ROM, and may be coupled to I/O subsystem 402 for storing information and instructions. Storage 410 is an example of a non-transitory computer-readable medium that may be used to store instructions and data which when executed by the processor 404 cause performing computer-implemented methods to execute the techniques herein.

The instructions in memory 406, ROM 408 or storage 410 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 400 may be coupled via I/O subsystem 402 to at least one output device 412. In one embodiment, output device 412 is a digital computer display. Examples of a display that may be used in various embodiments include a touch screen display or a light-emitting diode (LED) display or a liquid crystal display (LCD) or an e-paper display. Computer system 400 may include other type(s) of output devices 412, alternatively or in addition to a display device. Examples of other output devices 412 include printers, ticket printers, plotters, projectors, sound cards or video cards, speakers, buzzers or piezoelectric devices or other audible devices, lamps or LED or LCD indicators, haptic devices, actuators or servos.

At least one input device 414 is coupled to I/O subsystem 402 for communicating signals, data, command selections or gestures to processor 404. Examples of input devices 414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 416, which may perform cursor control or other automated control functions such as navigation in a graphical interface on a display screen, alternatively or in addition to input functions. Control device 416 may be a touchpad, a mouse, a trackball, or cursor direction keys for communicating direction information and command selections to processor 404 and for controlling cursor movement on output device (e.g., display) 412. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 414 may include a combination of multiple different input devices, such as a video camera and a depth sensor.

In another embodiment, computer system 400 may comprise an internet of things (IoT) device in which one or more of the output device 412, input device 414, and control device 416 are omitted. Or, in such an embodiment, the input device 414 may comprise one or more cameras, motion detectors, thermometers, microphones, seismic detectors, other sensors or detectors, measurement devices or encoders and the output device 412 may comprise a special-purpose display such as a single-line LED or LCD display, one or more indicators, a display panel, a meter, a valve, a solenoid, an actuator or a servo.

When computer system 400 is a mobile computing device, input device 414 may comprise a global positioning system (GPS) receiver coupled to a GPS module that is capable of triangulating to a plurality of GPS satellites, determining and generating geo-location or position data such as latitude-longitude values for a geophysical location of the computer system 400. Output device 412 may include hardware, software, firmware and interfaces for generating position reporting packets, notifications, pulse or heartbeat signals, or other recurring data transmissions that specify a position of the computer system 400, alone or in combination with other application-specific data, directed toward host 424 or server 430.

Computer system 400 may implement the techniques described herein using customized hard-wired logic, at least one ASIC, GPU, or FPGA, firmware and/or program instructions or logic which when loaded and used or executed in combination with the computer system causes or programs the computer system to operate as a special-purpose machine. According to one embodiment, the techniques herein are performed by computer system 400 in response to processor 404 executing at least one sequence of at least one instruction contained in main memory 406. Such instructions may be read into main memory 406 from another storage medium, such as storage 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 410. Volatile media includes dynamic memory, such as memory 406. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 402. Transmission media can also take the form of acoustic or light waves, such as those generated during radio-wave and infra-red data communications.

Various forms of media may be involved in carrying at least one sequence of at least one instruction to processor 404 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 400 can receive the data on the communication link and convert the data to a format that can be read by computer system 400. For instance, a receiver such as a radio frequency antenna or an infrared detector can receive the data carried in a wireless or optical signal and appropriate circuitry can provide the data to I/O subsystem 402 such as place the data on a bus. I/O subsystem 402 carries the data to memory 406, from which processor 404 retrieves and executes the instructions. The instructions received by memory 406 may optionally be stored on storage 410 either before or after execution by processor 404.

Computer system 400 also includes a communication interface 418 coupled to bus 402. Communication interface 418 provides a two-way data communication coupling to network link(s) 420 that are directly or indirectly connected to at least one communication networks, such as a network 422 or a public or private cloud on the Internet. For example, communication interface 418 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 422 broadly represents a local area network (LAN), wide-area network (WAN), campus network, internetwork or any combination thereof. Communication interface 418 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 418 sends and receives electrical, electromagnetic or optical signals over signal paths that carry digital data streams representing various types of information.

Network link 420 typically provides electrical, electromagnetic, or optical data communication directly or through at least one network to other data devices, using, for example, satellite, cellular, Wi-Fi, or BLUETOOTH technology. For example, network link 420 may provide a connection through a network 422 to a host computer 424.

Furthermore, network link 420 may provide a connection through network 422 or to other computing devices via internetworking devices and/or computers that are operated by an Internet Service Provider (ISP) 426. ISP 426 provides data communication services through a world-wide packet data communication network represented as internet 428. A server computer 430 may be coupled to internet 428. Server 430 broadly represents any computer, data center, virtual machine or virtual computing instance with or without a hypervisor, or computer executing a containerized program system such as DOCKER or KUBERNETES. Server 430 may represent an electronic digital service that is implemented using more than one computer or instance and that is accessed and used by transmitting web services requests, uniform resource locator (URL) strings with parameters in HTTP payloads, API calls, app services calls, or other service calls. Computer system 400 and server 430 may form elements of a distributed computing system that includes other computers, a processing cluster, server farm or other organization of computers that cooperate to perform tasks or execute applications or services. Server 430 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 430 may comprise a web application server that hosts a presentation layer, application layer and data storage layer such as a relational database system using structured query language (SQL) or no SQL, an object store, a graph database, a flat file system or other data storage.

Computer system 400 can send messages and receive data and instructions, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage 410, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 404. While each processor 404 or core of the processor executes a single task at a time, computer system 400 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

Although some of the figures described in the foregoing specification include flow diagrams with steps that are shown in an order, the steps may be performed in any order, and are not limited to the order shown in those flowcharts. Additionally, some steps may be optional, may be performed multiple times, and/or may be performed by different components. All steps, operations and functions of a flow diagram that are described herein are intended to indicate operations that are performed using programming in a special-purpose computer or general-purpose computer, in various embodiments. In other words, each flow diagram in this disclosure, in combination with the related text herein, is a guide, plan or specification of all or part of an algorithm for programming a computer to execute the functions that are described. The level of skill in the field associated with this disclosure is known to be high, and therefore the flow diagrams and related text in this disclosure have been prepared to convey information at a level of sufficiency and detail that is normally expected in the field when skilled persons communicate among themselves with respect to programs, algorithms and their implementation.

In the foregoing specification, the example embodiment(s) of the present invention have been described with reference to numerous specific details. However, the details may vary from implementation to implementation according to the requirements of the particular implement at hand. The example embodiment(s) are, accordingly, to be regarded in an illustrative rather than a restrictive sense.

What is claimed is:

1. A computer-implemented method for improving presentation of one or more content items in response to input on a user interface of a client computing device, the method comprising:
receiving, by an application, a plurality of content items associated with a particular slot in the user interface;
causing, by the application, a first content item of the plurality of content items to be displayed in the particular slot in the user interface presented on the client computing device;
after causing the first content item to be displayed in the particular slot, receiving, by the application, user input to scroll through the plurality of content items;
after scrolling through the plurality of content items, detecting that the particular slot is no longer in view;
in response to detecting that the particular slot is no longer in view, selecting, by the application, a second content item from the plurality of content items that is different from the first content item; and
causing, by the application, the second content item to be displayed in the particular slot in the user interface;
wherein the method is performed by one or more computing devices.

2. The computer-implemented method of claim 1, wherein each content item of the plurality of content items is from a different content provider.

3. The computer-implemented method of claim 1, further comprising:
determining whether the first content item was displayed in the particular slot a threshold number of times;
wherein selecting the second content item that is different from the first content item is also performed in response to determining that the first content item was displayed in the particular slot the threshold number of times.

4. The computer-implemented method of claim 1, further comprising:
detecting that at least a portion of the particular slot is in view; and
wherein selecting the second content item that is different from the first content item is also performed in response to detecting that the at least the portion of the particular slot is in view.

5. The computer-implemented method of claim 1, further comprising, after causing the second content item to be displayed in the particular slot:
associating a graphical element with the first content item;
receiving second user input that selects the graphical element while the second content item is displayed in the particular slot;
in response to receiving the second user input, replacing the second content item with the first content item; and
causing the first content item to be displayed in the particular slot.

6. The computer-implemented method of claim 1, further comprising:
determining that the first content item is displayed in the user interface to a particular user;
retrieving user interaction data for the particular user from a user interaction database, the user interaction data comprising an impression data set and a click data set;
wherein selecting the second content item from the plurality of content items is also performed based at least in part on the user interaction data for the particular user.

7. The computer-implemented method of claim 6, further comprising:
retrieving a click-through rate from the user interaction database;
wherein causing the first content item to be displayed in the particular slot is also performed based on the click-through rate;
receiving user input that selects the first content item while the first content item is displayed in the particular slot; and
updating the click-through rate based on the received user input.

8. The computer-implemented method of claim 1, further comprising:
determining that user interaction data for a particular user is unavailable;
identifying a similarity value for each user of a plurality of users who has viewed the first content item;
for each user of the plurality of users, determining whether the similarity value exceeds a threshold level of similarity;
for each user of the plurality of users whose similarity value exceeds the threshold level of similarity, collecting user interaction data from a user interaction database; and
aggregating the collected user interaction data to generate aggregated user data for the first content item;
wherein selecting the second content item from the plurality of content items is also performed based at least in part on the aggregated user data for the first content item.

9. The computer-implemented method of claim 1, further comprising:
determining an impression time for the first content item; and
determining whether the impression time for the first content item exceeds a threshold time;
wherein selecting the second content item that is different from the first content item is also performed in response to determining that the impression time for the first content item exceeds the threshold time.

10. The computer-implemented method of claim 1, further comprising:
determining a gap time between when the particular slot disappears from view and when the particular slot is back in view; and
determining that the gap time is greater than a particular threshold;
wherein selecting the second content item that is different from the first content item is also performed in response to determining the gap time is greater than the particular threshold.

11. One or more non-transitory computer-readable storage media storing instructions that, when executed by one or more processors, perform a method comprising:
receiving, by an application, a plurality of content items associated with a particular slot in the user interface;
causing, by the application, a first content item of the plurality of content items to be displayed in the particular slot in the user interface presented on the client computing device;
after causing the first content item to be displayed in the particular slot, receiving, by the application, user input to scroll through the plurality of content items;
after scrolling through the plurality of content items, detecting that the particular slot is no longer in view;
in response to detecting that the particular slot is no longer in view, selecting, by the application, a second content item from the plurality of content items that is different from the first content item; and
causing, by the application, the second content item to be displayed in the particular slot in the user interface;
wherein the method is performed by one or more computing devices.

12. The one or more non-transitory computer-readable storage media of claim 11, wherein each content item of the plurality of content items is from a different content provider.

13. The one or more non-transitory computer-readable storage media of claim 11, when executed, the method further comprising:
determining whether the first content item was displayed in the particular slot a threshold number of times;
wherein selecting the second content item that is different from the first content item is also performed in response to determining that the first content item was displayed in the particular slot the threshold number of times.

14. The one or more non-transitory computer-readable storage media of claim 11, when executed, the method further comprising:
detecting that at least a portion of the particular slot is in view; and
wherein selecting the second content item that is different from the first content item is also performed in response to detecting that the at least the portion of the particular slot is in view.

15. The one or more non-transitory computer-readable storage media of claim 11, when executed, the method further comprising, after causing the second content item to be displayed in the particular slot:
associating a graphical element with the first content item;
receiving second input that selects the graphical element while the second content item is displayed in the particular slot;
in response to receiving the second user input, replacing the second content item with the first content item; and
causing the first content item to be displayed in the particular slot.

16. The one or more non-transitory computer-readable storage media of claim 11, when executed, the method further comprising:
determining that the first content item is displayed in the user interface to a particular user;
retrieving user interaction data for the particular user from a user interaction database, the user interaction data comprising an impression data set and a click data set;
wherein selecting the second content item from the plurality of content items is also performed based at least in part on the user interaction data for the particular user.

17. The one or more non-transitory computer-readable storage media of claim 16, when executed, the method further comprising:
retrieving a click-through rate from the user interaction database;
wherein causing the first content item to be displayed in the particular slot is also performed based on the click-through rate;
receiving user input that selects the first content item while the first content item is displayed in the particular slot; and
updating the click-through rate based on the received user input.

18. The one or more non-transitory computer-readable storage media of claim 11, when executed, the method further comprising:
determining that user interaction data for a particular user is unavailable;
identifying a similarity value for each user of a plurality of users who has viewed the first content item;
for each user of the plurality of users, determining whether the similarity value exceeds a threshold level of similarity;
for each user of the plurality of users whose similarity value exceeds the threshold level of similarity, collecting user interaction data from a user interaction database; and
aggregating the collected user interaction data to generate aggregated user data for the first content item;
wherein selecting the second content item from the plurality of content items is also performed based at least in part on the aggregated user data for the first content item.

19. The one or more non-transitory computer-readable storage media of claim 11, when executed, the method further comprising:
determining an impression time for the first content item; and
determining whether the impression time for the first content item exceeds a threshold time;
wherein selecting the second content item that is different from the first content item is also performed in response to determining that the impression time for the first content item exceeds the threshold time.

20. A system comprising:
a processor; and
a memory storing instructions that, when executed by the processor, cause the processor to:
receive, by an application, a plurality of content items associated with a particular slot in the user interface;
cause, by the application, a first content item of the plurality of content items to be displayed in the particular slot in the user interface presented on the client computing device;
after causing the first content item to be displayed in the particular slot, receive, by the application, user input to scroll through the plurality of content items;
after scrolling through the plurality of content items, detect that the particular slot is no longer in view;
in response to detecting that the particular slot is no longer in view, select, by the application, a second content item from the plurality of content items that is different from the first content item; and
cause, by the application, the second content item to be displayed in the particular slot in the user interface.
